(19) United States
(12) Patent Application Publication
(10) Pub. No.: US 2026/0295967 A1
(43) Pub. Date: Oct. 1, 2026

(54) HOT MOPPED ASPHALT ROOFING SYSTEMS INCORPORATING POLYISOCYANURATE COVERBOARDS

(71) Applicant: Johns Manville, Denver, CO (US)

(72) Inventors: Lauren Bajo-Smith, Chula Vista, CA (US); Richard Barnes, Littleton, CO (US)

(21) Appl. No.: 19/089,138

(22) Filed: Mar. 25, 2025

(51) Int. Cl. B32B 5/18; B32B 3/26; B32B 7/12; B32B 37/06; E04D 1/28; E04D 1/34

(52) U.S. Cl. CPC B32B 5/18; B32B 3/266; B32B 7/12; B32B 37/06; E04D 1/28; B32B 2250/03; B32B 2250/40; B32B 2266/0278; B32B 2307/72; B32B 2307/7375; B32B 2375/00; B32B 2395/00; B32B 2419/06; E04D 2001/3435

(57) ABSTRACT

A roofing system may include a roofing substrate. The roofing system may include a first layer of asphalt-containing adhesive overlaying the roofing substrate. The roofing system may include a layer of insulation overlaying the first layer of asphalt-containing adhesive. The roofing system may include a second layer of asphalt-containing adhesive the layer of insulation. The roofing system may include a polyisocyanurate coverboard overlaying the second layer of asphalt-containing adhesive. The polyisocyanurate coverboard may include a first patterned facer coupled with a first surface of a polyisocyanurate core. The polyisocyanurate coverboard may include a second patterned facer coupled with a second surface of the polyisocyanurate core opposite the first surface of the polyisocyanurate core. The roofing system may include a third layer of asphalt-containing adhesive overlaying the polyisocyanurate coverboard. The roofing system may include a roofing membrane system overlaying the third layer of asphalt-containing adhesive.

### BACKGROUND

Commercial and industrial buildings typically have roofs with low-slope roof decks. The roofing systems for these roofs with low-slope roof decks may typically include one or more layers of a low-density roofing insulation, one or more layers of roofing coverboard that overlie the low-density roofing insulation layer(s), and a waterproofing membrane that overlies the roofing coverboard(s). The layer(s) of low-density insulation, such as a low-density polymer-based foam insulation, if not protected, can be partially crushed or otherwise damaged from worker traffic over the insulation, the placement of heaving objects on the insulation, the weather, and other causes commonly encountered in roofing construction. The layer(s) of roofing cover board that overlie the layer(s) of low-density insulation may protect the more fragile low-density insulation from damage, may serve as a fire barrier, may provide a suitable substrate for the attachment of the overlying waterproofing membrane, and may augment the insulating function of the layer(s) of low-density insulation. The uppermost waterproofing membrane layer overlying the coverboard layer may protect the underlying coverboard and insulation layers from moisture and other adverse climatic conditions. Normally, these three components (the low-density insulation boards, the roofing coverboards, and the waterproofing membrane) of the roofing system are separately manufactured and separately and successively applied to the low-slope roof deck.

In a “built up roof” (BUR) system, multiple components such as the low-density insulation boards, the roofing coverboards, and the waterproofing membrane may be joined using liquid asphalt. That is, liquid asphalt may be applied to low-density insulation boards to allow for the application and joinder of the roofing coverboards. Subsequently, liquid asphalt may again be applied to the roofing coverboards to allow for the application and joinder of the waterproofing membrane. The liquid asphalt may be applied using a hot mop technique where hot liquid asphalt (heated to temperatures in excess of 300° F.) is applied with a large mop.

While polyisocyanurate coverboards, for example, may provide excellent thermal insulation, flame resistance, and other mechanical properties, these polyisocyanurate coverboards have not typically been used in hot mop BUR systems. The polyisocyanurate coverboards may sustain damage when contacted with the hot liquid asphalt. This damage makes polyisocyanurate coverboards unsuitable. However, due to the desirable properties of the polyisocyanurate coverboards, inclusion of polyisocyanurate coverboards in hot mop BUR systems is desired.

### BRIEF SUMMARY

Embodiments of the present technology may improve the performance of roofing systems, such as by enabling the use of polyisocyanurate coverboards in hot mopped asphalt roofing applications.

The present technology is generally directed to roofing systems. A roofing system may include a roofing substrate. The roofing system may include a first layer of asphalt-containing adhesive overlaying the roofing substrate. The roofing system may include a polyisocyanurate coverboard overlaying the first layer of asphalt-containing adhesive. The polyisocyanurate coverboard may include a first patterned facer coupled with a first surface of a polyisocyanurate core. The polyisocyanurate coverboard may include a second patterned facer coupled with a second surface of the polyisocyanurate core opposite the first surface of the polyisocyanurate core. The roofing system may include a second layer of asphalt-containing adhesive overlaying the polyisocyanurate coverboard. The roofing system may include a roofing membrane system overlaying the second layer of asphalt-containing adhesive.

In embodiments, the roofing substrate may be or include at least one of an existing roof, a partially torn off roof, or a roof deck. The asphalt-containing adhesive may be or include hot mopped asphalt. One or both of the first patterned facer and/or the second patterned facer may be or include at least one of fiberglass, felt, foil, or paper. The first patterned facer and the second patterned facer each include a plurality of apertures. One or both of the first patterned facer and the second patterned facer may be characterized by an aperture density of greater than or about 100 apertures per square foot. One or both of the first patterned facer and the second patterned facer may be characterized by an aperture density of less than or about 1,000 apertures per square foot. One or both of the first patterned facer and the second patterned facer may include apertures characterized by an area of less than or about 9.1 mm².

The present technology is also generally directed to roofing coverboards. Roofing coverboards may include a foam core having a first surface and a second surface opposite the first surface. A first patterned facer may be coupled to the first surface of the foam core. The first patterned facer may be characterized by an aperture density of greater than or about 100 first apertures per square foot. A second patterned facer may be coupled with the second surface of the foam core. The second patterned facer may be characterized by an aperture density of greater than or about 100 second apertures per square foot.

In embodiments, a distance between the first surface and the second surface may be greater than or about 6.0 mm. The one or more first apertures and/or the one or more second apertures may extend less than or about 3.2 mm into the foam core. The one or more first apertures and/or the one or more second apertures may be characterized by an area of less than or about 9.1 mm². The first patterned facer and/or the second patterned facer may include fiberglass, felt, foil, or paper. The foam core may be or include a polyisocyanurate core. The foam core may be characterized by a density of greater than or about 1.5 lbs/ft³.

The present technology is also generally directed to roofing methods. The roofing methods may include applying a first layer of asphalt-containing adhesive to a roofing substrate. The roofing methods may include applying a polyisocyanurate coverboard over the first layer of asphalt-containing adhesive. The polyisocyanurate coverboard may include a first patterned facer coupled with a first surface of a polyisocyanurate core. The polyisocyanurate coverboard may include a second patterned facer coupled with a second surface of the polyisocyanurate core opposite the first surface of the polyisocyanurate core. The roofing methods may include applying a second layer of asphalt-containing adhesive to the polyisocyanurate coverboard. The roofing methods may include applying a roofing membrane over the second layer of asphalt-containing adhesive.

In embodiments, one or both of the second layer of asphalt-containing adhesive and the third layer of asphalt-containing adhesive may be applied at a temperature of greater than or about 300° C. The asphalt-containing adhesive may be or include one or both of a Type III and Type IV mopped asphalt. The first patterned facer and the second patterned facer each may include a plurality of apertures. Each of the plurality of apertures extend less than or about 3.2 mm into the polyisocyanurate core. The roofing membrane may include a base sheet and a cap sheet overlaying the base sheet.

### BRIEF DESCRIPTION OF THE DRAWINGS

FIG. 1 illustrates a construction of a commercial roof deck in accordance with embodiments of the invention.

FIG. 2 illustrates an embodiment of a polyisocyanurate foam board.

FIGS. 3A-3B illustrate embodiments of a facer, in accordance with embodiments of the invention.

FIG. 3C illustrates an embodiment of a polyisocyanurate foam board with patterned facers, in accordance with embodiments of the invention.

FIG. 4 illustrates is a method of forming a polyisocyanurate foam board, in accordance with embodiments of the invention.

FIG. 5 illustrates an embodiment of a roller for forming apertures in a facer, in accordance with embodiments of the invention.

FIG. 6 illustrates is a method of forming a roofing system, in accordance with embodiments of the invention.

### DETAILED DESCRIPTION OF THE INVENTION

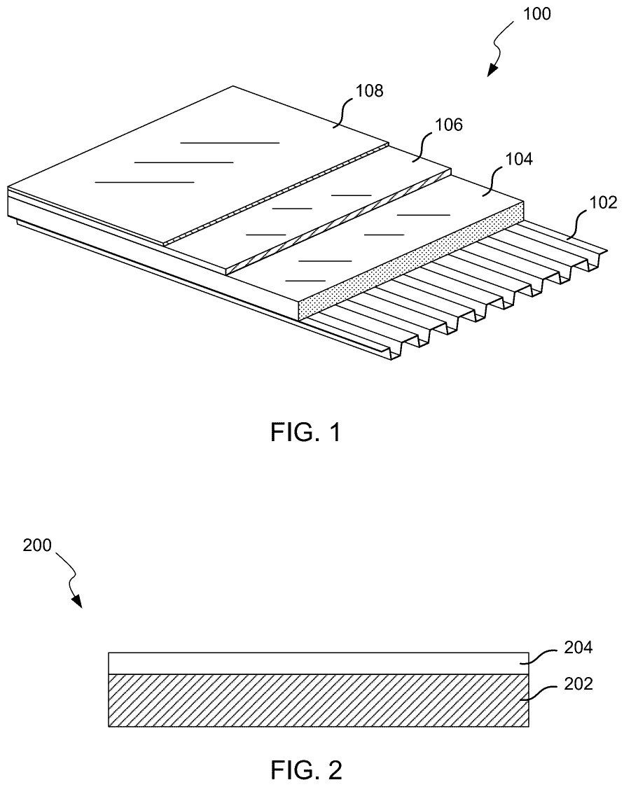

Referring now to FIG. 1, a construction of a commercial roof deck (i.e., roof system 100) is shown. The roof system 100 may be a BUR system. Roof system 100 may include a structural deck 102, which may be commonly made of steel or galvanized metal (18 to 22 gauge), although other types of materials and/or sizes are possible. The structural deck 102 may be commonly positioned above steel, metal, or other joists and supported thereby. In embodiments, structural deck 102 may be or include an existing roof, a partially torn off/damaged roof, and/or a roof deck, such as a newly constructed roof deck. A plurality of insulation boards 104 may be positioned atop the structural deck 102 to form an insulative layer of the roofing system 100. The insulation boards 104 may include polyisocyanurate-based boards, perlite-based boards, gypsum-based boards, fiberglass-based boards, other foam-based boards, and the like.

A plurality of coverboards 106 may be positioned atop the insulation boards 104 to add a protective layer to roofing system 100. The coverboards 106 may be added for fire and/or mechanical protection (e.g., hail or impact resistance) or for various other reasons. Similar to the insulation boards 104, in embodiments, the coverboards 106 may include polyisocyanurate-based boards, perlite-based boards, gypsum-based boards, and the like. In some embodiments, the coverboards 106 may be boards embodying the present technology as further discussed below. A density of a core of the coverboards 106 may be between about 1.50 lb/ft³ and about 7.0 lb/ft³. A thickness of the coverboards 106 may be between about 6.0 mm and about 20.0 mm, such as about 6.4 mm, about 12.7 mm, or about 19.1 mm. As further discussed below, one or more facers may be disposed on the coverboards 106, such as on a surface or surfaces of the coverboards 106 defining the largest surface area. Commonly, facer may be disposed on opposite surfaces of the coverboards 106 defining the largest surface area. The facers may have a thickness of between about 0.3 mm and about 5.0 mm.

A roofing membrane 108 may be positioned atop the roofing system 100. The roofing membrane 108 may be positioned atop the coverboards 106, insulation boards 104, and/or another component/layer of the roofing system 100. The roofing membrane 108 may include a base layer, or base sheet, and a top membrane, or cap sheet, overlying the base sheet. In some embodiments, the roofing membrane 108 may include modified bitumen, thermoplastic olefin (TPO), ethylene propylene diene monomer (EPDM), metal, a waterproof membrane, and the like. The modified bitumen may be, for example, an oxidized asphalt base ply, an atactic polypropylene (APP) base sheet, or a styrene-butadiene-styrene (SBS) base sheet. The waterproof membrane may be, for example, an oxidized asphalt cap sheet, an APP cap sheet, a SBS cap sheet, or a fleece backed (felt) single ply membrane. One exemplary roofing membrane 108 may be a modified bitumen base layer with a waterproof top membrane. The roofing membrane 108 may be ballasted, adhered, mechanically fastened, and the like atop the roofing system 100 to couple the roofing membrane 108 with the roofing system's components/layers. Further, individual components of the waterproof membrane 108 may be coupled together to form the roofing membrane 108. For example, individual TPO segments, sheets, or strips may be heat welded together to form a substantially continuous TPO layer atop the roofing system 100. Similarly, individual EPDM segments may be adhered or bonded together, and metal segments may be mechanically fastened or bonded to form a substantially continuous membrane layer.

The roofing system 100 may be slightly sloped to promote drainage of water and/or for various other reasons as desired. The roof system 100 may also include other components, layers, and/or materials that are not shown, such as bonding cement, primer, acoustic infills, and the like.

Roofing systems may include those described in U.S. application Ser. No. 14/299,631, now U.S. Pat. No. 9,528,269, which is incorporated herein by reference for all purposes.

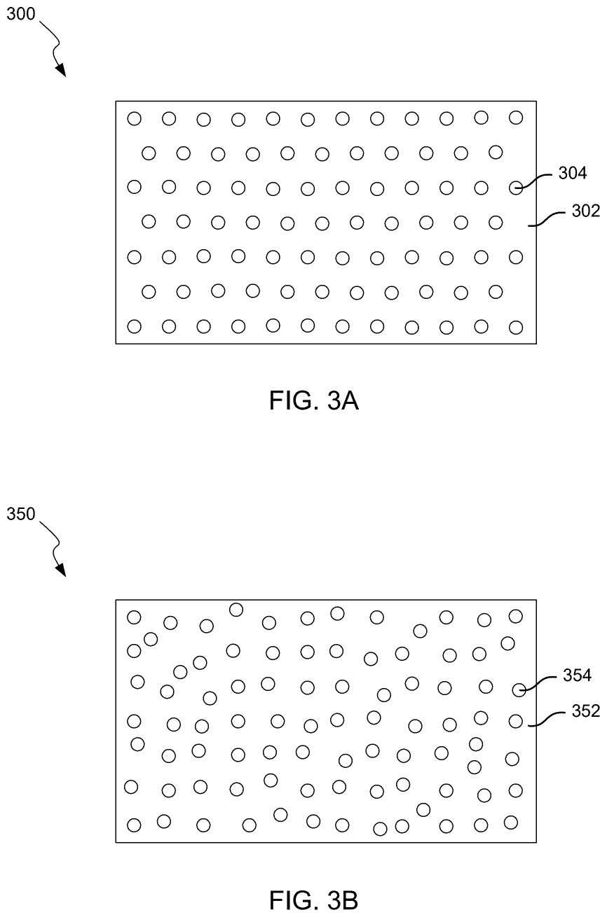

Referring now to FIG. 2, illustrated is an embodiment of a polyisocyanurate foam board 200, which may be used as insulation boards 104 and/or coverboards 106 in roofing system 100. The polyisocyanurate foam board 200 may include a polyisocyanurate core 202 that is produced from an isocyanate, a polyol, and a blowing agent. Other components may also be used in producing the polyisocyanurate core 202. The polyisocyanurate core 202 typically may be characterized by an average foam cell size of less than or about 300 microns. The average foam cell size of the polyisocyanurate core 202 may relate to the R-value of the polyisocyanurate coverboard 200. For example, lower average foam cell size may result in increased R-value.

The polyisocyanurate foam board 200 may be characterized by different core densities. For example, a lower density foam insulation board, such as insulation boards 104, may be characterized by a core density of between about 1.5 lbs/ft³ and about 5 lbs/ft³, including between about 1.6 lbs/ft³ and about 4 lbs/ft³, such as between about 1.8 lbs/ft³ and about 3 lbs/ft³, or any ranges or values therebetween. A higher density coverboard, such as coverboards 106, may be characterized by a foam core density of up to about 12 lbs/ft³, including between about 5 lbs/ft³ and about 10 lbs/ft³. For coverboard purposes, a polyisocyanurate foam board 200 in accordance with embodiments of the invention may preferably be characterized by a core density of between about 1.5 lbs/ft³ and about 7.0 lbs/ft³.

A thickness of the polyisocyanurate core 202 may be between about 6.0 mm and about 19.2 mm, such as about 6.4 mm, about 12.7 mm, or about 19.1 mm. As such, a distance from a first surface of the polyisocyanurate core 202 to a second surface of polyisocyanurate core 202 opposite the first surface may be between about 6.0 mm and about 19.2 mm, such as about 6.4 mm, about 12.7 mm, or about 19.1 mm. Depending on the core density of the foam insulation board, a compressive strength range of the polyisocyanurate foam board 200 may be between about 1 lbs/inch² and about 140 lbs/inch². For example, polyisocyanurate foam board 200 with low core density foam may be characterized by a compressive strength of between about 1 lbs/inch² and about 35 lbs/inch². Polyisocyanurate foam board 200 with high core density may be characterized by a compressive strength of between about 80 lbs/inch² and about 140 lbs/inch².

The polyisocyanurate foam board 200 may also include an optional facer material 204. The facer material 204 may be applied to at least one surface of the polyisocyanurate core 202. The facer material 204 may typically include fiberglass (woven or non-woven), felt, foil, paper, plastic, a plastic/fiberglass composite, and/or a polyester mat (which may include a reactive binder such as urethanes and/or ureas). The facer material 204 is typically selected based on the type of polyisocyanurate coverboard being produced. For example, facers for polyisocyanurate coverboards that are used in roofing applications may include: coated polymer bonded glass fiber mat, which provides desired characteristics, such as low porosity, fire retardancy, mechanical strength, and the like. In such embodiments, the facer 204 may be characterized by a thickness of between about 0.3 mm and about 5.0 mm, such as between about 1.5 mm and about 3.2 mm.

Although FIG. 2 illustrates the facer 204 being positioned on a single side of the polyisocyanurate core 202, it should be realized that in many embodiments an additional facer may be positioned on the opposite side of the polyisocyanurate core 202. The additional facer may be the same, a similar, or a different facer than facer 204 and/or may be characterized by a different thickness and/or material coating as desired.

Referring again to FIG. 1, various means may be used to join or fasten the insulation boards 104 to the structural deck 102, the coverboards 106 to the insulation boards 104, and/or the roofing membrane 108 to the coverboards 106. For example, any adhesive, cement, or mechanical fastener may be used to join or fasten any of the components of the roof system 100. Exemplary adhesives may include, but are not limited to, asphalt-based adhesives, solvent-based adhesives, water-based adhesives, and polyurethane-based adhesives. Asphalt-based adhesives may be applied as a hot-melt adhesive or as a cold-applied adhesive. Exemplary asphalt-based adhesive may be Type III or Type IV mopped asphalt, which may be applied at temperatures in excess of 300° C. Solvent-based adhesives may be made from synthetic materials and may be applied using a solvent, which may evaporate as the adhesive dries. Water-based adhesives may be made from water-soluble polymers and may be applied as a liquid. Polyurethane-based adhesives may be a single-component or a multi-component formulation.

The adhesive or cement may be applied as a liquid, a foam, a spray, or a tape. The type of adhesive may at least partially dictate how the adhesive is applied. For example, asphalt-based adhesives may typically be applied as a liquid or a tape. Additionally, each of the components may be joined using the same or different means, which may benefit the materials being joined.

The means for joining or fastening the insulation boards 104 to the structural deck 102, the coverboards 106 to the insulation boards 104, and/or the roofing membrane 108 to the coverboards 106 may aid in durability, longevity, safety, and other characteristics of the roofing system 100. For example, asphalt-based adhesives may provide an impermeable roofing system 100. When applied in several layers between various components, asphalt-based adhesives may prevent the formation of any seams that may leak. Additionally, in warmer temperatures, the asphalt-based adhesive may soften and self-seal and seams, gaps, or cracks, that may have formed, such as during colder temperatures. As such, the asphalt-based adhesive may be self-curing over time. Further, asphalt-based adhesives are typically quick and easy to apply.

Conventional polyisocyanurate coverboards typically have not been used in roofing systems using asphalt-based adhesives, especially asphalt-based adhesives applied as a hot-melt adhesive (e.g., hot mopped asphalt roofing). In fact, the roofing industry as a whole has not listed hot mopped asphalt as an approved adhesive for installing polyisocyanurate coverboards. When polyisocyanurate coverboards have been attempted to be used in hot mopped asphalt roofing applications, the asphalt-based adhesives damage the polyisocyanurate coverboards. As previously discussed, polyisocyanurate coverboards commonly have facers applied to both surfaces of the polyisocyanurate core. When asphalt-based adhesives applied as a hot-melt adhesive contact the polyisocyanurate coverboards, gaseous materials in the polyisocyanurate core may form and may be trapped by the facer(s). For example, pentane (C₅H₁₂) and/or carbon dioxide (CO₂) may be trapped in the polyisocyanurate core. With continued formation of these gaseous materials, cells within the polyisocyanurate core may begin to burst. Additionally, the facer(s) may begin to delaminate and/or separate from the polyisocyanurate core. This damage may reduce the performance of the polyisocyanurate coverboard and the entire roofing system.

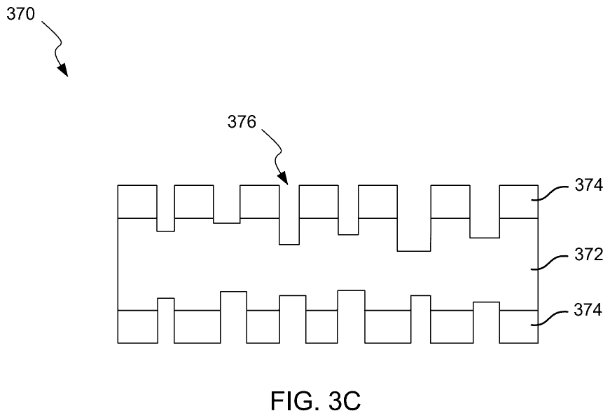

The present technology may include patterned facer(s) on polyisocyanurate coverboards that allow the coverboards to be used in hot mopped asphalt roofing applications. While seemingly unconventional, patterning the facer(s) may allow high temperature adhesives, such as hot mopped asphalt, to be applied at elevated temperatures while reducing and/or minimizing damage to the underlying foam core. Referring now to FIGS. 3A-3B, a facer 300, 350 that may be applied to a polyisocyanurate coverboard, such as coverboards 106 or as facer 204, are illustrated. The facer 300, 350 may include a sheet 302, 352 that may be patterned to define a plurality of apertures 304, 354. As illustrated in FIG. 3A, the plurality of apertures 304 may be uniformly patterned (i.e., such as at regular intervals or equal spacing between individual apertures) on the sheet 302. Additionally, the plurality of apertures 304 may be uniformly off set, such that adjacent rows of apertures may not be vertically aligned. Instead, the plurality of apertures 304 in a first row may define a non-patterned portion of the sheet 300 between adjacent apertures 304. An adjacent row of apertures may be offset, such that the adjacent two of the plurality of apertures is 304 may be shifted horizontally and vertically spaced from non-patterned portion of the sheet 300 of the adjacent row. By uniformly patterning the plurality of apertures 304 or offsetting the plurality of apertures 304, a number of apertures 304 may be maximized across the facer 300. As further discussed, an increased number of apertures 304 may assist with outgassing of gaseous materials may be improved, further limiting damage that may result to the underlying foam core. Conversely, as illustrated in FIG. 3B, the plurality of apertures 354 may be non-uniformly (i.e., such as at irregular intervals or non-equal spacing between individual apertures) or randomly patterned on the sheet 352.

In either case, a uniformly patterned plurality of apertures 304 or a non-uniformly patterned plurality of apertures 354, the sheet 302, 352 of the facer 300, 350 may be characterized by an aperture density of greater than or about 50 apertures per square foot, such as greater than or about 60 apertures per square foot, greater than or about 70 apertures per square foot, greater than or about 80 apertures per square foot, greater than or about 90 apertures per square foot, greater than or about 100 apertures per square foot, greater than or about 110 apertures per square foot, greater than or about 120 apertures per square foot, greater than or about 130 apertures per square foot, greater than or about 140 apertures per square foot, greater than or about 150 apertures per square foot, greater than or about 175 apertures per square foot, greater than or about 200 apertures per square foot, greater than or about 250 apertures per square foot, or more. With an increased aperture density, outgassing of gaseous materials may be improved, further limiting damage that may result in hot mopped asphalt roofing applications. The outgassing of gaseous materials may assist with heat dissipation.

However, at very high aperture densities, the facer(s) may not cover a sufficient amount of the polyisocyanurate core. This may frustrate the purpose of the facer(s) and diminish integrity of the polyisocyanurate coverboard. As such, the sheet 302, 352 of the facer 300, 350 may be characterized by an aperture density of less than or about 1,000 apertures per square foot, such as less than or about 900 apertures per square foot, less than or about 800 apertures per square foot, less than about 700 apertures per square foot, less than or about 600 apertures per square foot, less than or about 500 apertures per square foot, less than or about 250 apertures per square foot, less than or about 225 apertures per square foot, less than or about 200 apertures per square foot, less than or about 175 apertures per square foot, less than or about 150 apertures per square foot, or less.

Additionally, the plurality of apertures 304, 354 may define openings in between about 0.1% and about 5.0% of the surface area of the sheet 302, 352 of the facer 300, 350. In embodiments, if the plurality of apertures 304, 354 define a higher amount of openings in the surface area of the sheet 302, 352, the facer 300, 350 may lose structural integrity as an excessive portion of the underlying foam core may be exposed. Conversely, if the apertures 304, 354 define openings in less than or about 0.1% of the surface area of the sheet 302, 352 of the facer 300, 350, the amount of openings may not be sufficient to allow outgassing and prevent blistering during hot mopped roofing applications. In embodiments, the plurality of apertures 304, 354 may define openings in less than or about 5.0% of the surface area of the sheet 302, 352 of the facer 300, 350, such as less than or about 4.5%, less than or about 4.0%, less than or about 3.5%, less than or about 3.0%, less than or about 2.5%, less than or about 2.0%, less than or about 1.5%, less than or about 1.0%, less than or about 0.8%, less than or about 0.6%, less than or about 0.4%, less than or about 0.2%, or less. Conversely, the plurality of apertures 304, 354 may define openings in greater than or about 0.1% of the surface area of the sheet 302, 352 of the facer 300, 350, such as greater than or about 0.2%, greater than or about 0.4%, greater than or about 0.6%, greater than or about 0.8%, greater than or about 1.0%, greater than or about 1.5%, less than or about 2.0%, greater than or about 2.5%, greater than or about 3.0%, greater than or about 3.5%, greater than or about 4.0%, greater than or about 4.5%, or more.

While illustrated as circular or round apertures, it is contemplated that the plurality of apertures 304, 354 may be characterized by any shape. For example, the plurality of apertures 304, 354 may be an oval, a triangle, a square, a rectangle, a pentagon, a quadrilateral, a hexagon, an octagon, or any other geometric shape.

Additionally, the plurality of apertures 304, 354 may be more than a single shape on the sheet 302, 352 of the facer 300, 350. For example, the plurality of apertures 304, 354 may include both circular apertures and rectangular apertures.

In addition to aperture density, to preserve integrity and performance of the facer 300, 350 and resultant coverboard, the plurality of apertures 304, 354 may be characterized by a reduced area. For a circular aperture, such as those illustrated in FIGS. 3A-3B, a needle may be used to puncture the sheet 302, 352 of the facer 300, 350. The needle may be characterized by any gauge and may be between, for example, a 34 gauge needle and a 10 gauge needle. In embodiments, the area of the aperture may be less than or about 9.1 mm², which may correspond with the outer diameter of a 10 gauge needle. However, this area is not to be limited to the area of a circle and may be attributed to the area of any of the previously discussed geometric shapes. In embodiments, the area of the aperture may be less than or about 8.5 mm², such as less than or about 8.0 mm², less than or about 7.5 mm², less than or about 7.0 mm², less than or about 6.5 mm², less than or about 6.0 mm², less than or about 5.5 mm², less than or about 5.0 mm², less than or about 4.5 mm², less than or about 4.0 mm², less than or about 3.5 mm², less than or about 3.0 mm², less than or about 2.5 mm², less than or about 2.0 mm², less than or about 1.5 mm², less than or about 1.0 mm², less than or about 0.5 mm², less than or about 0.1 mm², less than or about 0.05 mm², less than or about 0.02 mm², which may correspond with the outer diameter of a 34 gauge needle, or less.

While illustrated as having substantially uniform sizes, it is contemplated that the plurality of apertures 304, 354 may be characterized by any size. For example, a first portion of the plurality of apertures 304, 354 may be a first size or characterized by a first area while a second portion of the plurality of apertures 304, 354 may be a second size or characterized by a second area that is smaller or larger than the first area.

To limit damage of the polyisocyanurate core, the plurality of apertures 304, 354 on the sheet 302, 352 of the facer 300, 350 may be characterized by a minimal depth into the underlying polyisocyanurate core, such that the aperture punctures the facer 300, 350 while minimally extending into the polyisocyanurate core. As such, the plurality of apertures 304, 354 may not extend through an entire thickness of the underlying polyisocyanurate core. In embodiments, the patterning of the plurality of apertures 304, 354 may extend less than or about 3.2 mm into the underlying polyisocyanurate core, such as less than or about 3.0 mm, less than or about 2.8 mm, less than or about 2.6 mm, less than or about 2.4 mm, less than or about 2.2 mm, less than or about 2.0 mm, less than or about 1.8 mm, less than or about 1.6 mm, less than or about 1.4 mm, less than or about 1.2 mm, less than or about 1.0 mm, less than or about 0.8 mm, less than or about 0.6 mm, less than or about 0.4 mm, less than or about 0.2 mm, less than or about 0.1 mm, or less.

Additionally, the patterning of the plurality of apertures 304, 354 may extend less than or about 50% into the thickness of the underlying polyisocyanurate core, such as less than or about 45%, less than or about 40%, less than or about 35%, less than or about 30%, less than or about 25%, less than or about 20%, less than or about 15%, less than or about 10%, less than or about 8%, less than or about 6%, less than or about 5%, less than or about 4%, less than or about 2%, less than or about 1%, or less. In embodiments, the plurality of apertures 304, 354 may only extend through the facer 300, 350. As such, the plurality of apertures 304, 354 may not extend into the underlying polyisocyanurate core. As illustrated in FIG. 3C, it is contemplated that the plurality of apertures 304, 354 may extend different amounts into the underlying polyisocyanurate core. For example, a first portion of the plurality of apertures 304, 354 may extend a first distance into the thickness of the underlying polyisocyanurate core while a second portion of the plurality of apertures 304, 354 may extend a second distance into the thickness of the underlying polyisocyanurate core that is smaller or larger than the first distance.

Referring to FIG. 3C, a polyisocyanurate coverboard 370 according to the present technology is illustrated. The polyisocyanurate coverboard 370 may include a polyisocyanurate core 372 and a facer 374 on at least one side of the polyisocyanurate core 372. As illustrated, the polyisocyanurate coverboard 370 may include a facer 374 on both sides of the polyisocyanurate core 372. A plurality of apertures 376 may extend through each facer 374. The plurality of apertures 376 may at least partially extend into the polyisocyanurate core 372. However, it is also contemplated that the plurality of aperture 376 may not extend into polyisocyanurate core 372 and may only extend through each facer 374.

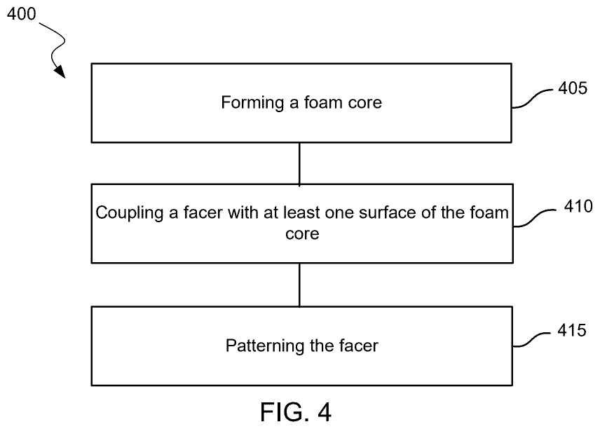

Referring to FIG. 4, a method 400 of forming a coverboard with a patterned facer is illustrated. At block 405, a foam core may be formed. In embodiments, the foam core may be a polyisocyanurate core. The foam core may include any of the features or characteristics of the previously discussed foam core(s), including the polyisocyanurate core(s). Polyisocyanurate foams, such as the foam core formed at block 405, be made by combining separate liquid mixtures that include polyisocyanates (the A-side mixture) and polyols (the B-side mixture). The A-side mixture and B-side mixture can be combined to form the polyisocyanurate foam product. A blowing agent may be used, typically in the B-side mixture, to cause the foaming of the formulation, creating a cellular structure having good insulating properties. A common blowing agent may include pentane.

The A-side mixture may include one or more polyisocyanate compounds.

Example polyisocyanates may include substituted or unsubstituted polyisocyanates, and may more specifically include aromatic, aliphatic, and cycloaliphatic polyisocyanates having at least two isocyanate functional groups. Specific example aromatic polyisocyanates include 4,4′-diphenylmethane diisocyanate (MDI), polymeric MDI (PMDI), toluene disisocyanate, and allophanate modified isocyanate. A commercial example of an isocyanate formulation that may be used in the present formulations is Wannate® PM-700 manufactured by Wanhua Chemical Group Co., Ltd. of Yantai, China. This isocyanate formulation may have a viscosity of about 600 mPa-S at 25° C., a functionality of about 2.9, and an isocyanate content of about 30.4%.

In embodiments, the A-side mixture may account for greater than or about 50 wt. % of the polyisocyanurate foam, such as greater than or about 52. % wt. %, such as greater than or about 55 wt. %, such as greater than or about 57.5 wt. %, such as greater than or about 60 wt. %, such as greater than or about 62.5 wt. %, such as greater than or about 65 wt. %, such as greater than or about 66 wt. %, or such as less than or about 70 wt. %, such as less than or about 67.5 wt. %, or any ranges or values therebetween.

The B-side mixture of the polyisocyanurate foam, also referred to as the first component herein, may include one or more polyol compounds. The polyol compound typically includes either or both a polyether and polyester having a hydroxyl number between about 25 and 500, and more commonly between about 200 and 270. The hydroxyl number is a measure of the concentration of the hydroxyl group in the polyol, which is expressed as the milligrams of KOH (potassium hydroxide) equivalent to the hydroxyl groups in one gram of polyol. Polyether is commonly not used in conventional polyisocyanurate foam boards because it is typically less flame resistant than the aromatic polyester that is used in such boards. A lower hydroxyl number commonly results in longer polymer chains and/or less cross linking, which results in a relatively loose polymer chain. In contrast, a higher hydroxyl number commonly results in more cross linking and/or shorter polymer chains, which may provide enhanced mechanical properties and/or flame resistance.

Example polyols may include polyether polyols, polyester polyols, polycarbonate polyols, aromatic polyols (including polyester polyols, PET-based polyols, and polyamide-based polyols), and mannich polyols. Polyether polyols may be made by polymerizing one or more types of epoxides, such as ethylene oxide or propylene oxide. The polyether polyol may also be made by polymerizing the epoxide with a polyol such as a diol (e.g., glycol), triol (e.g., glycerin), or other polyol. Example polyether polyols may include polyether diols such as polyether polyethylene glycol, polypropylene glycol, and poly(tetramethylene ether) glycol, among other polyether diols.

Polyester polyols may be made by the stepwise polymerization of polyols and polycarboxylic acids. For example, polyester polyols may be formed by the reaction of a glycol such as diethylene glycol with a dicarboxylic acid such as phthalic acid to form an aromatic polyester polyol. Commercially available polyester polyols that may be used with the present formulations include those sold by Invista, including Terate® HT 5503 and Terate® HT 5349. TerateR HT 5503 may have a hydroxyl number between 224 and 245, and a functionality of about 2.0. Terate® HT 5349 may have a hydroxyl number between 295 and 315, and a functionality of about 2.45. The polyols used may be only polyester polyols and may exclude other polyols.

Polycarbonate polyols are a special class of polyester polyol, which can be produced through polycondensation of diols with phosgene or transesterification of diols, such as hexane diol, with carbonic acid ester. Polycarbonate polyols may be produced from propylene oxide and carbon dioxide blended with dibasic ester under catalytic condition. The carbon dioxide may account for approximately 40% of the polyol mass. The polyol may have a functionality of about 2.0 and may have hydroxyl number of about 72. Commercial available polycarbonate polyols include Converge® Polyol sold by Novomer, now Saudi Aramco. The polycarbonate polyol may be used as blend with polyester polyol such as Terate® HT 5503.

Nonetheless, in embodiments, the polyol component may be a polyester polyol, or a blend of polyester polyols, but may not include one or more non-polyester polyols. Regardless of the polyol or polyols utilized, the polyol component may be present in an amount of less than or about 25 wt. % based upon the weight of the polyisocyanurate foam, such as less than or about 22.5 wt. %, such as less than or about 20 wt. %, such as less than or about 18 wt. %, or such as greater than or about 5 wt. %, such as greater than or about 7.5 wt. %, such as greater than or about 10 wt. %, such as greater than or about 12.5 wt. %, such as greater than or about 15 wt. %, such as greater than or about 17.5 wt. %, or any ranges or values therebetween.

Catalysts used in polyisocyanurate foam formulations normally include trimerization catalysts that catalyze the formation of cyclic isocyanurate trimers from the polyisocyanate reactant. Example trimerization catalysts include tertiary amines, such as 1, 3, 5-tris(3-(dimethylamino) propyl)-hexahydro-triazine and quaternary ammonium salts, such DABCO-TMR and DABCO-TMR2 sold by AirProducts, now Evonik. Example catalysts may also include metal catalysts, such as potassium octoate and potassium acetate. Example catalysts that may be useful in embodiments of the invention include OMG 977™ and OMG 1123™ catalysts sold by Borchers OM Group, and TMR-20™ catalyst sold by Evonik. Quaternary ammonium salts, such as TMR™ or TMR2™, and metal catalysts, such as TMR-20™, are particularly effective in promoting trimer formation at high index.

In embodiments, the one or more catalysts may be present in an amount of about 1 part to about 15 parts per 100 parts of the one or more polyester polyols, such as greater than or about 2 parts, such as greater than or about 4 parts, such as greater than or about 6 parts, such as greater than or about 8 parts, such as greater than or about 10 parts, or such as less than or about 14 parts, such as less than or about 12 parts, or any ranges or values therebetween. Stated differently, in embodiments, the one or more catalysts may be present in an amount of about 0.1 wt. % to about 5 wt. % based upon the weight of the polyisocyanurate foam, such as greater than or about 0.2 wt. %, such as greater than or about 0.4 wt. %, such as greater than or about 0.6 wt. %, such as greater than or about 0.8 wt. %, such as greater than or about 1 wt. %, such as greater than or about 1.2 wt. %, such as greater than or about 1.4 wt. %, such as greater than or about 1.6 wt. %, such as greater than or about 1.8 wt. %, such as greater than or about 2 wt. %, such as greater than or about 2.5 wt. %, or such as less than or about 4 wt. %, such as less than or about 3.5 wt. %, such as less than or about 3 wt. %, such as less than or about 2.5 wt. %, such as less than or about 2.25 wt. %, such as less than or about 2 wt. %, such as less than or about 1.9 wt. %, or any ranges or values therebetween.

The present polyisocyanurate formulations may also include one or more surfactants. The surfactants function to improve compatibility of the formulation components and stabilize the cell structure during foaming. Example surfactants can include organic or silicone based materials, or non-silicone materials. Example surfactants that may be useful in embodiments of the invention include Niax Silicone L6900 (Momentive), Tegostab B84506 (Evonik Industries), Vorasurf™ sold by The Dow Chemical Company and DC 193 sold by Dow Corning Company.

In embodiments, the one or more surfactants may be present in an amount of about 0.1 part to about 5 parts per 100 parts of the one or more polyester polyols, such as greater than or about 0.2 parts, such as greater than or about 0.4 parts, such as greater than or about 0.6 parts, such as greater than or about 0.8 parts, such as greater than or about 1 part, or such as less than or about 1.4 parts, such as greater than or about 1.6 parts, such as greater than or about 1.8 parts, such as greater than or about 2 parts, or such as less than or about 4.5 parts, such as less than or about 4 parts, such as less than or about 3.5 parts, such as less than or about 3 parts, such as less than or about 2.5 parts, such as less than or about 2 parts, such as less than or about 1.75 parts, or any ranges or values therebetween. Stated differently, in embodiments, the one or more surfactants may be present in an amount of about 0.01 wt. % to about 1 wt. % based upon the weight of the polyisocyanurate foam, such as greater than or about 0.02 wt. %, such as greater than or about 0.04 wt. %, such as greater than or about 0.06 wt. %, such as greater than or about 0.08 wt. %, such as greater than or about 0.1 wt. %, such as greater than or about 0.12 wt. %, such as greater than or about 0.14 wt. %, such as greater than or about 0.16 wt. %, such as greater than or about 0.18 wt. %, such as greater than or about 0.2 wt. %, such as greater than or about 0.22 wt. %, such as greater than or about 0.24 wt. %, such as greater than or about 0.26 wt. %, such as greater than or about 0.28 wt. %, or such as less than or about 0.9 wt. %, such as less than or about 0.8 wt. %, such as less than or about 0.7 wt. %, such as less than or about 0.6 wt. %, such as less than or about 0.5 wt. %, such as less than or about 0.4 wt. %, such as less than or about 0.3 wt. %, or any ranges or values therebetween.

The present polyisocyanurate formulations may also include the non-halogenated and/or halogenated fire retardants. In some embodiments, the polyisocyanurate formulation may include a halogenated fire retardant such as tris(2-chloroisopropyl)phosphate (TCPP). In some embodiments, a non-halogenated fire retardant may include a non-halogenated fire retardant such as diethyl hydroxylmethyl phosphonate (DEHMP). The non-halogenated fire retardant may reduce the amount of halogenated fire retardants such as TCPP use in the foams. The polyisocyanurate core may be able to form a sufficiently stable char when exposed to flame conditions in accordance with ASTM E-84. The stable char enables the polyisocyanurate core to pass the ASTM E-84 test. The polyisocyanurate foam insulation boards may exhibit an ASTM E1354-11b performance that is equivalent with or better than a similar polyisocyanurate foam insulation board having a traditional halogenated or non-halogenated fire retardant that does not have a foam index discussed herein.

The phosphorus containing non-halogenated fire retardant may include: an organo-phosphate, an organo-phosphite, and/or an organo-phosphonate. The non-halogenated organo phosphorus fire retardant could be non-reactive or reactive (i.e., containing isocyanate reactive functionality). An example non-reactive organa phosphorus fire retardant is a butyl diphenyl phosphate, dibutyl phenyl phosphate, and triphenyl phosphate, as well as combinations thereof. Example reactive organa phosphorus fire retardants include diethyl hydroxylmethyl phosphonate (DEHMP) and diethyl N, N-bis(2-hydroxyethyl)aminomethylphosphonate (DEHAMP, also known as Fyrol 6) sold by ICL and Lanxess. In other embodiments, the phosphorous containing non-halogenated fire retardant may include: dialkyl hydroxyalkanephosphonate (e.g., dimethyl hydroxymethylphosphonate), diaryl hydroxyalkanephosphonate (e.g., diphenyl hydroxymethylphosphonate), and the like.

Regardless of the fire retardant or retardants selected, the one or more fire retardants may be present in an amount of about 1 part to about 25 parts per 100 parts of the one or more polyester polyols, such as greater than or about 2.5 parts, such as greater than or about 5 parts, such as greater than or about 6 parts, such as greater than or about 8 parts, such as greater than or about 10 parts, such as greater than or about 12 parts, such as greater than or about 14 parts, such as greater than or about 15 parts, or such as less than or about 22.5 parts, such as less than or about 20 parts, such as less than or about 17.5 parts or any ranges or values therebetween. Stated differently, in embodiments, the one or more fire retardants may be present in an amount of about 0.1 wt. % to about 5 wt. % based upon the weight of the polyisocyanurate foam, such as greater than or about 0.2 wt. %, such as greater than or about 0.4 wt. %, such as greater than or about 0.6 wt. %, such as greater than or about 0.8 wt. %, such as greater than or about 1 wt. %, such as greater than or about 1.2 wt. %, such as greater than or about 1.4 wt. %, such as greater than or about 1.6 wt. %, such as greater than or about 1.8 wt. %, such as greater than or about 2 wt. %, such as greater than or about 2.5 wt. %, such as greater than or about 2.7 wt. %, or such as less than or about 4.5 wt. %, such as less than or about 4 wt. %, such as less than or about 3.5 wt. %, such as less than or about 3 wt. %, such as less than or about 2.75 wt. %, such as less than or about 2.5 wt. %, or any ranges or values therebetween. Surprisingly, the polyisocyanurate foams according to the present technology provide insulation with excellent fire retardancy and strength even at low fire retardant concentrations.

Embodiments of the present polyisocyanurate formulations may further include one or more of initiators and carbohydrates. Unlike catalysts, an initiator is consumed during the polymerization reaction and becomes part of the polyisocyanurate foam product. Example initiators may include aliphatic and aromatic polyamines, such as ethylene diamine, toluene diamines such as a combination of 3,5-diethyltoluene-2,4-diamine and 3,5-diethyltoluene-2,6-diamine sold under the tradename Ethacure® 100 by Albemarle Corp, and polyetheramines such as Jeffamine® T-403 and D-230 sold by Huntsman Corporation, among others. A carbohydrate may include a monosaccharide, an oligosaccharide, and/or a polysaccharide. Specific examples include sucrose and/or high-fructose corn syrup (HFCS), among other carbohydrates. While the carbohydrates include a plurality of hydroxyl groups, they are not believed to react with the polyisocyanates to as great an extent as the urethane polyols, and in some formulations they may not react at all.

The blowing agents used to make the foam may include hydrocarbon gas (e.g., n-pentane, isopentane, cyclo-pentane, etc.) and/or fluorocarbon gas, among others. The blowing agent may include a mixture of isopentane and n-pentane. Specific examples of fluorocarbon gases may include HFC-245fa (i.e., 1,1,1,3,3-pentafluoropropane) commercially available under the tradename Enovate® from Honeywell Corp., HFC-365mfc (i.e., CF₃CH₂CF₂CH₃), HFC-134a (i.e., 1,1,1,2-tetrafluoroethane), HCFO 1233zd (i.e., trans-1-chloro-3,3,3-trifluoropropene) sold under tradname Solstice® LBA by Honeywell Corp., Forane® 1233zd by Arkema, and HFO-1336mzz (1,1,1,4,4,4-hexafluoro-2-butene) sold under trade name Opteon 1100 by Chemours. The blowing agent may be in the B-side mixture. In some embodiments, the blowing agent is a 50/50 mixture of n-pentane and isopentane.

In embodiments, the blowing agent may be present in an amount of about 15 parts to about 45 parts per 100 parts of the one or more polyester polyols, such as greater than or about 17.5 parts, such as greater than or about 20 parts, such as greater than or about 22.5 parts, such as greater than or about 25 parts, such as greater than or about 27.5 parts, or such as less than or about 42.5 parts, such as less than or about 40 parts, such as less than or about 37.5 parts, such as less than or about 35 parts, such as less than or about 32.5 parts, or any ranges or values therebetween. Stated differently, in embodiments, the one or more blowing agents may be present in an amount of about 1 wt. % to about 10 wt. % based upon the weight of the polyisocyanurate foam, such as greater than or about 1.5 wt. %, such as greater than or about 2 wt. %, such as greater than or about 2.5 wt. %, such as greater than or about 3 wt. %, such as greater than or about 3.5 wt. %, such as greater than or about 4 wt. %, such as greater than or about 4.5 wt. %, such as greater than or about 5 wt. %, such as greater than or about 5.25 wt. %, such as greater than or about 5.5 wt. %, or such as less than or about 9 wt. %, such as less than or about 8.5 wt. %, such as less than or about 8 wt. %, such as less than or about 7.5 wt. %, such as less than or about 7 wt. %, such as less than or about 6.5 wt. %, such as less than or about 6 wt. %, or any ranges or values therebetween.

In embodiments, water may react with isocyanate in the mixture to generate carbon dioxide, which acts as a blowing agent.

Embodiments of the present technology also include one or more multi-functional alcohols. In embodiments, the one or more multi-functional alcohols has a molecular weight of from about 80 g/mol to about 20,000 g/mol, such as less than or about 15,000 g/mol, such as less than or about 12,500 g/mol, such as less than or about 10,000 g/mol, such as less than or about 9,000 g/mol, such as less than or about 8,000 g/mol, such as less than or about 7,000 g/mol, such as less than or about 6,000 g/mol, such as less than or about 5,000 g/mol, such as less than or about 4,000 g/mol, such as less than or about 3,000 g/mol, such as less than or about 2,000 g/mol, such as less than or about 1,000 g/mol, such as less than or about 500 g/mol, or such as greater than or about 100 g/mol, such as greater than or about 250 g/mol, such as greater than or about 500 g/mol, such as greater than or about 750 g/mol, such as greater than or about 1,000 g/mol, or any ranges or values therebetween.

In addition, the one or more multi-functional alcohols may have a functionality of greater than 2 active hydrogen per molecule, such as greater than 3, such as greater than 4, such as greater than 5, such as greater than 6, such as greater than 7, such as up to about 8, or such as less than 8, such as less than 7, such as less than 6, or any ranges or values therebetween.

In embodiments, the one or more multi-functional alcohols include aliphatic, cycloaliphatic, aromatic, heterocyclic polyhydric alcohols, a triglyceride based natural oil polyol, a functionalized natural oil such as castor oil or hydroxylated epoxidized natural oil, as well as combinations thereof. For instance, in embodiments, the one or more multi-functional alcohols may be or include triethanolamine (TEA), glycerol, trimethylol ethane, tri-methylol propane, pentaerythritol, di-pentaerythritol, tripentaerythritol, methyl glucoside, alkoxylated glycerol, alkoxylated pentaerythritol, alkoxylated methyl glucoside, alkoxylated sucrose, alkoxylated sorbitol, alkoxylated trimethylol ethane, alkoxylated trimethylol propane, amine polyol (such as Jeffol A-630, A-800 from Huntsman and Quadrol from BASF), Mannich polyol (such as Jeffol R-470X), or combinations thereof.

Regardless of the one or more multi-functional alcohols selected, the present technology has surprisingly found that the polyisocyanurate foam may exhibit the excellent properties when greater than 20 parts of the one or more multi-functional alcohols are utilized per 100 parts of the polyester polyol, such as greater than or about 22.5 parts, such as greater than or about 25 parts, such as greater than or about 27.5 parts, such as greater than or about 30 parts, as greater than or about 32.5 parts, such as greater than or about 35 parts, such as greater than or about 37.5 parts, such as greater than or about 40 parts, such as greater than or about 42.5 parts, such as greater than or about 45 parts, such as greater than or about 47.5 parts, as greater than or about 50 parts, such as greater than or about 52.5 parts, such as greater than or about 55 parts, such as greater than or about 57.5 parts, such as greater than or about 60 parts, or such as less than or about 80 parts, such as less than or about 70 parts, such as less than or about 60 parts, such as greater than or about 62.5 parts, such as greater than or about 65 parts, such as less than or about 55 parts, such as less than or about 50 parts, such as less than or about 45 parts, such as less than or about 42.5 parts, or any ranges or values therebetween. Nonetheless in embodiments, it may be desirable to utilize amounts greater than 20 parts, such as greater than or about 22.5 parts, but less than or about 40 parts, in order to obtain the excellent stability and fire retardancy properties while also maintaining good processability.

Stated differently, in embodiments, the one or more multi-functional alcohols may be present in an amount of about 1 wt. % to about 10 wt. % based upon the weight of the polyisocyanurate foam (and therefore the polyisocyanurate core), such as greater than or about 1.5 wt. %, such as greater than or about 2 wt. %, such as greater than or about 2.5 wt. %, such as greater than or about 3 wt. %, such as greater than or about 3.5 wt. %, such as greater than or about 4 wt. %, such as greater than or about 4.5 wt. %, such as greater than or about 5 wt. %, such as greater than or about 5.25 wt. %, such as greater than or about 5.5 wt. %, or such as less than or about 9 wt. %, such as less than or about 8.5 wt. %, such as less than or about 8 wt. %, such as less than or about 7.5 wt. %, such as less than or about 7 wt. %, such as less than or about 6.5 wt. %, such as less than or about 6 wt. %, such as less than or about 5.5 wt. % or any ranges or values therebetween. The B-side mixture may also include an emulsifier.

An example formulation for a polyisocyanurate foam insulation may have an isocyanate index less than 260, such as less than or about 250, such as less than or about 240, such as less than or about 230, as compared to commercial polyisocyanurate foams which exhibit a foam index of greater than 260, such as generally greater than 270. When a polyisocyanate reacts with a polyol to form a urethane bond, one NCO group reacts with one OH group. As is known in the art, the index is defined as the ratio of NCO group to OH group as shown in the formula below:

$$Index = \frac{Moles of NCO group}{Moles of OH group} \times 100$$

When the number of NCO groups equals the number of OH groups in a formulation, a stoichiometric NCO:OH ratio of 1.0 is realized and a polyurethane polymer/foam is produced. When the number of NCO groups is significantly more than the number of OH groups in a formulation, the excess isocyanate group reacts with itself under catalytic condition to form isocyanurate linkage and polyisocyanurate foam is produced. Surprisingly, unlike prior guidance an index of less than 250, such as even less than or about 240, which provides a ratio of less than 2.5:1 NCO groups to OH groups, has been found to provide an excellent structural integrity, thermal strength and/or stability, and fire resistance, even at lower foam indexes as discussed herein.

A polyisocyanurate formulation according to the present technology may also have a metallo-organic compound as part of its B-side mixture. For example, a compound of zinc or bismuth with various coordinating organic ligands may be used, and may impart favorable properties to the resulting foam. An example of an additive including a zinc compound and usable in embodiments of the invention is KKAT®XK-614 Zinc complex available from King Industries, Inc. USA. An example of a bismuth additive usable in embodiments of the invention is KKAT®-XC-C227 Bismuth complex, 2-ethylhexanoic acid (CAS 149-57-5) also sold by King Industries, Inc. USA. In some embodiments, the metallo-organic compound may include carbon, and may be for example a zinc salt such as a zinc carboxylate. In some embodiments, the metallo-organic compound may be about 0.1 to 1.0 weight percent of the B-side mixture.

At block 410, one or more facers may be coupled with at least one surface of the foam core. Commonly, a facer may be coupled with opposite surfaces of the foam core. The facer(s) may include any of the features or characteristics of the previously discussed facer(s). The facer(s) may be coupled using an adhesive or may be coupled with the foam core before the foam core has set or cured. For example, the foam core may still be setting and tacky, allowing the facer(s) to be applied without the use of an adhesive. In embodiments, the one or more facers may be coupled the foam core after the foam core has set. Alternatively, the foam core may be formed over a facer or between two facers. If formed over a facer, a second facer may be coupled with an opposite surface while the foam core is setting or after the foam core has set, such as with or without an adhesive.

At block 415, the facer(s) may be patterned to form a plurality of apertures. The plurality of apertures may include any of the features or characteristics of the previously discussed plurality of apertures. The apertures may be formed by a needling press or roller, for example, to pattern the facer(s). The facer(s) may be patterned simultaneously or sequentially. As previously discussed, the plurality of apertures may extend through the facer(s) and minimally through the underlying foam.

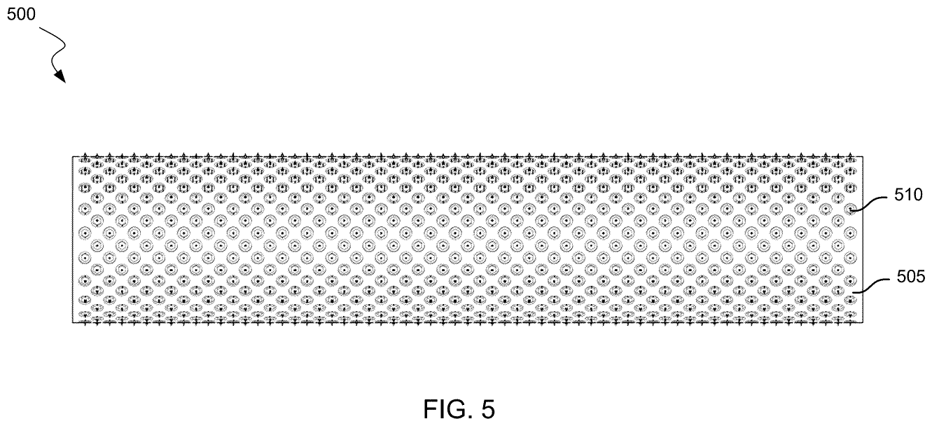

Referring to FIG. 5, an exemplary roller 500 is illustrated. A body 505 of the roller 500 may be characterized by a cylindrical shape. However, it is contemplated that the body 505 of the roller may be characterized by other shapes. For example, the body of the roller 500 may be planar and may be stamped on the facer being patterned. Whether cylindrical or planar, a plurality of pins 510 may be disposed on the body 505 of the roller 500. The pins 510 may include needles as previously discussed for forming apertures in the facer being patterned. The pins 510 may be threaded such that pins can individually be replaced over time, such as if the needle on the pin 510 becomes dull and no longer effectively forms apertures.

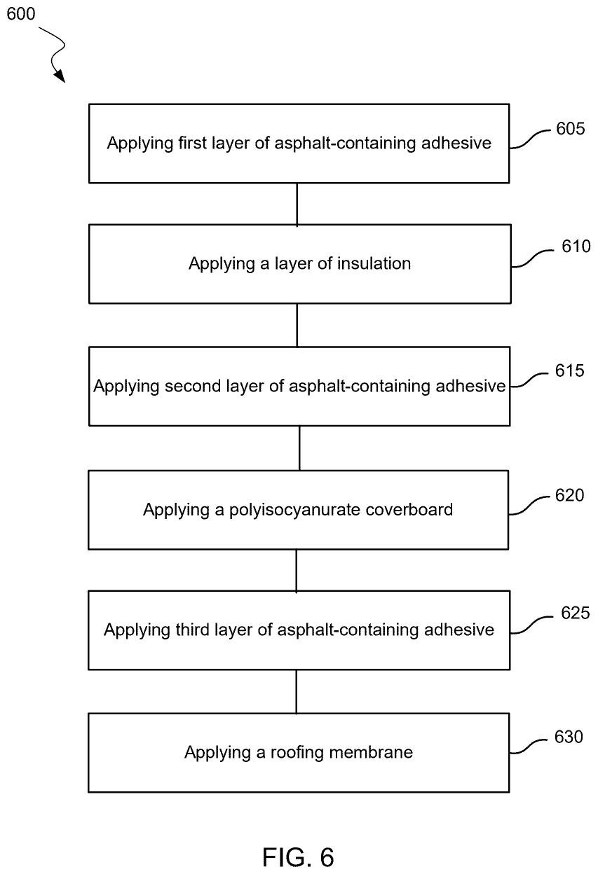

Referring to FIG. 6, a method 600 of forming a roofing system is illustrated. At block 605, a first layer of asphalt-containing adhesive may be applied to a roofing substrate. At block 610, a layer of insulation may be applied over the first layer of asphalt-containing adhesive. At block 615, a second layer of asphalt-containing adhesive may be applied to the layer of insulation. At block 620, a polyisocyanurate coverboard may be applied over the second layer of asphalt-containing adhesive. The polyisocyanurate coverboard may include any of the features or characteristics of the coverboards previously discussed. For example, the polyisocyanurate coverboard may include a first patterned facer coupled with a first surface of a polyisocyanurate core. The polyisocyanurate coverboard may also include a second patterned facer coupled with a second surface of the polyisocyanurate core opposite the first surface of the polyisocyanurate core. At block 625, a third layer of asphalt-containing adhesive may be applied to the polyisocyanurate coverboard. At block 630, a roofing membrane system may be applied over the third layer of asphalt-containing adhesive.

While some of the asphalt-containing adhesive may enter the polyisocyanurate coverboard, such as through the plurality of apertures, any effect on the polyisocyanurate coverboard may be minimal or nominal. Due to the reduced diameter and depth of penetration of the plurality of apertures, surface contact between the polyisocyanurate core and the asphalt-containing adhesive may not be significant enough to damage the polyisocyanurate coverboard.

The asphalt-containing adhesive used in method 600 may be include any of the features or characteristics of the asphalt-based adhesives previously discussed. For example, the asphalt-containing adhesive used in method 600 may be a Type Ill or Type IV mopped asphalt. As such, the asphalt-containing adhesive applied at blocks 505, 515, and/or 525 may be applied with a mop or other mop-like application tool. In embodiments, the asphalt-containing adhesive may be applied at a temperature of greater than or about 300° C., such as greater than or about 350° C., greater than or about 400° C., greater than or about 425° C., greater than or about 450° C., greater than or about 475° C., or more. However, the patterned facer(s) may not be able to withstand extremely elevated temperatures, resulting in damage to the polyisocyanurate coverboard. As such, the asphalt-containing adhesive may be applied at a temperature of less than or about 500° C., such as less than or about 475° C., less than or about 450° C., less than or about 425° C., less than or about 400° C., less than or about 375° C., or less.

Subsequent layers of material, such as the layer of insulation, the polyisocyanurate coverboard, and/or the roofing membrane system may be applied while the asphalt-containing adhesive is still at an elevated temperature, such as any of the previously discussed temperatures. As such, the asphalt-containing adhesive may still be molten, hot, and/or tacky to adhere to and join the next material to the previous, underlying material.

As described herein, at least one facer of a foam insulation board may be patterned to define a plurality of apertures. As previously discussed, the plurality of apertures may assist with heat dissipation and outgassing, permitting the use of a foam insulation board, such as a polyisocyanurate coverboard, in a hot mopped roofing application. As such, a roofing system according to the present technology may include a foam insulation board, such as a polyisocyanurate coverboard, with at least one patterned facer. The foam insulation board with at least one patterned facer may be incorporated in a roofing system, such as roofing system 100. In such an embodiment, the foam insulation board may be encapsulated with an asphalt-based adhesive hot mopped asphalt.

All patents, patent publications, patent applications, journal articles, books, technical references, and the like discussed in the instant disclosure are incorporated herein by reference in their entirety for all purposes.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

“About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A roofing system, comprising:
a roofing substrate;
a first layer of asphalt-containing adhesive overlaying the roofing substrate;
a polyisocyanurate coverboard overlaying the first layer of asphalt-containing adhesive, the polyisocyanurate coverboard comprising:
a first patterned facer coupled with a first surface of a polyisocyanurate core; and
a second patterned facer coupled with a second surface of the polyisocyanurate core opposite the first surface of the polyisocyanurate core;
a second layer of asphalt-containing adhesive overlaying the polyisocyanurate coverboard; and
a roofing membrane system overlaying the second layer of asphalt-containing adhesive.

2. The roofing system of claim 1, wherein the roofing substrate comprises at least one of an existing roof, a partially torn off roof, or a roof deck.

3. The roofing system of claim 1, wherein the asphalt-containing adhesive comprises hot mopped asphalt.

4. The roofing system of claim 1, wherein one or both of the first patterned facer and the second patterned facer comprise at least one of fiberglass, felt, foil, or paper.

5. The roofing system of claim 1, wherein:
the first patterned facer and the second patterned facer each comprise a plurality of apertures; and
one or both of the first patterned facer and the second patterned facer are characterized by an aperture density of greater than or about 100 apertures per square foot.

6. The roofing system of claim 1, wherein:
the first patterned facer and the second patterned facer each comprise a plurality of apertures; and
one or both of the first patterned facer and the second patterned facer are characterized by an aperture density of less than or about 1,000 apertures per square foot.

7. The roofing system of claim 1, wherein one or both of the first patterned facer and the second patterned facer comprise apertures characterized by an area of less than or about 9.1 mm².

8. A roofing coverboard, comprising:
a foam core having a first surface and a second surface opposite the first surface;
a first patterned facer coupled to the first surface of the foam core, wherein the first patterned facer is characterized by an aperture density of greater than or about 100 first apertures per square foot; and
a second patterned facer coupled with the second surface of the foam core, wherein the second patterned facer is characterized by an aperture density of greater than or about 100 second apertures per square foot.

9. The roofing coverboard of claim 8, wherein a distance between the first surface and the second surface is greater than or about 6.0 mm.

10. The roofing coverboard of claim 8, wherein the one or more first apertures and/or the one or more second apertures extend less than or about 3.2 mm into the foam core.

11. The roofing coverboard of claim 8, wherein the one or more first apertures and/or the one or more second apertures are characterized by an area of less than or about 9.1 mm².

12. The roofing coverboard of claim 8, wherein the first patterned facer and/or the second patterned facer comprise fiberglass, felt, foil, or paper.

13. The roofing coverboard of claim 8, wherein the foam core comprises a polyisocyanurate core.

14. The roofing coverboard of claim 8, wherein the foam core is characterized by a density of greater than or about 1.5 lbs/ft³.

15. A roofing method, comprising:
applying a first layer of asphalt-containing adhesive to a roofing substrate;
applying a polyisocyanurate coverboard over the second layer of asphalt-containing adhesive, the polyisocyanurate coverboard comprising:
a first patterned facer coupled with a first surface of a polyisocyanurate core; and
a second patterned facer coupled with a second surface of the polyisocyanurate core opposite the first surface of the polyisocyanurate core;
applying a second layer of asphalt-containing adhesive to the polyisocyanurate coverboard; and
applying a roofing membrane over the second layer of asphalt-containing adhesive.

16. The roofing method of claim 15, wherein one or both of the first layer of asphalt-containing adhesive and the second layer of asphalt-containing adhesive are applied at a temperature of greater than or about 300° C.

17. The roofing method of claim 15, wherein the asphalt-containing adhesive comprises one or both of a Type III and Type IV mopped asphalt.

18. The roofing method of claim 15, wherein the first patterned facer and the second patterned facer each comprise a plurality of apertures.

19. The roofing method of claim 18, wherein each of the plurality of apertures extend less than or about 3.2 mm into the polyisocyanurate core.

20. The roofing method of claim 15, wherein the roofing membrane comprises:
a base sheet; and
a cap sheet overlaying the base sheet.
